(19) United States
(12) Patent Application Publication
(10) Pub. No.: US 2024/0323636 A1
(43) Pub. Date: Sep. 26, 2024

(54) SOUND PROCESSING DEVICE, SOUND PROCESSING METHOD, AND RECORDING MEDIUM

(71) Applicant: Panasonic Intellectual Property Corporation of America, Torrance, CA (US)

(72) Inventors: Seigo ENOMOTO, Kyoto (JP); Kota NAKAHASHI, Osaka (JP); Tomokazu ISHIKAWA, Osaka (JP)

(21) Appl. No.: 18/676,834

(22) Filed: May 29, 2024

Related U.S. Application Data
(63) Continuation of application No. PCT/JP2022/042915, filed on Nov. 18, 2022.

(30) Foreign Application Priority Data
Dec. 9, 2021 (JP) 2021-200227

(51) Int. Cl. H04S 7/00

(52) U.S. Cl. CPC H04S 7/304; H04S 7/306; H04S 2420/01

(57) ABSTRACT

A sound processing device includes: a first processing unit generating a first output sound signal by convoluting, to sound information including a reproduced sound, a first head-related transfer function for localizing sound included in information as sound that arrives from the predetermined direction; a second processing unit generating a second output sound signal by convoluting, to the sound information, a second head-related transfer function for localizing sound included in information as sound that arrives from a first direction forming a first angle larger than 0° and smaller than 360° with respect to the predetermined direction and has a first delay time larger than 0 and a first volume attenuation larger than 0 with respect to the reproduced sound perceived by means of the first output sound signal; and a combiner combining the first output sound signal and the second output sound signal generated to output an output sound signal.

### CROSS REFERENCE TO RELATED APPLICATIONS

This is a continuation application of PCT International Application No. PCT/JP2022/042915 filed on Nov. 18, 2022, designating the United States of America, which is based on and claims priority of Japanese Patent Application No. 2021-200227 filed on Dec. 9, 2021. The entire disclosures of the above-identified applications, including the specifications, drawings and claims are incorporated herein by reference in their entirety.

### FIELD

The present disclosure relates to a sound processing device, and a sound processing method and a recording medium that relate to the sound processing device.

### BACKGROUND

There is known a technology relating to sound reproduction for causing a user to perceive a stereophonic sound in a virtual three-dimensional space by controlling the position of a sound image, which is a sensory sound source object (see, for example, Patent Literature (PTL) 1).

### CITATION LIST

### Patent Literature

[PTL 1] Japanese Unexamined Patent Application Publication No. 2020-18620

### SUMMARY

### Technical Problem

In causing the user to perceive a sound as a stereophonic sound in a three-dimensional sound field, there can occur the case where a sound that is less perceivable by the user is generated. Some of the information processing methods used in, for example, the conventional sound reproduction devices fail to appropriately process such a sound that is less perceivable.

In view of the above, the present disclosure aims to provide a sound processing device and so forth capable of causing a user to perceive a stereophonic sound in a more appropriate manner.

### Solution to Problem

The sound processing device according to an aspect of the present disclosure is a sound processing device that causes a user to perceive a reproduced sound as sound that arrives from a predetermined direction in a three-dimensional sound field. Such sound processing device includes: a first processing unit that generates a first output sound signal by convoluting, to sound information including the reproduced sound, a first head-related transfer function for localizing sound included in information as sound that arrives from the predetermined direction; a second processing unit that generates a second output sound signal by convoluting, to the sound information, a second head-related transfer function for localizing sound included in information as sound that arrives from a first direction and has a first delay time larger than 0 and a first volume attenuation larger than 0 with respect to the reproduced sound perceived by means of the first output sound signal, the first direction being a direction that forms a first angle larger than 0° and smaller than 360° with respect to the predetermined direction; and a combiner that combines the first output sound signal and the second output sound signal that are generated to output an output sound signal obtained by combining the first output sound signal and the second output sound signal.

Also, the sound processing method according to an aspect of the present disclosure is a sound processing method of causing a user to perceive a reproduced sound as sound that arrives from a predetermined direction in a three-dimensional sound field. Such sound processing method includes: generating a first output sound signal by convoluting, to sound information including the reproduced sound, a first head-related transfer function for localizing sound included in information as sound that arrives from the predetermined direction; generating a second output sound signal by convoluting, to the sound information, a second head-related transfer function for localizing sound included in information as sound that arrives from a first direction and has a first delay time larger than 0 and a first volume attenuation larger than 0 with respect to the reproduced sound perceived by means of the first output sound signal, the first direction being a direction that forms a first angle larger than 0° and smaller than 360° with respect to the predetermined direction; and combining the first output sound signal and the second output sound signal that are generated to output an output sound signal obtained by combining the first output sound signal and the second output sound signal.

An aspect of the present disclosure can also be realized in the form of a non-transitory computer-readable recording medium having recorded thereon a program for causing a computer to execute the foregoing sound processing method.

Note that these general or specific aspects may be implemented in the form of a system, a device, a method, an integrated circuit, a computer program, or a non-transitory, computer-readable recording medium such as a CD-ROM.

Alternatively, these general or specific aspects of the present disclosure may be implemented in the form of an optical disc that stores computer or such program a non-transitory, computer-readable recording medium such as an HDD and a semiconductor memory. These general or specific aspects may also be implemented using any combination of systems, devices, methods, integrated circuits, computer programs, or recording media.

### Advantageous Effects

According to the present disclosure, it is possible to cause a user to perceive a stereophonic sound in a more appropriate manner.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a schematic diagram showing usage examples of a sound processing device according to an embodiment.

FIG. 2 is a block diagram showing the functional configuration of a sound reproduction device according to the embodiment.

FIG. 3 is a block diagram showing a more detailed functional configuration of the sound processing device according to the embodiment.

FIG. 4 is a diagram for explaining volume attenuation according to the embodiment.

FIG. 5 is a diagram for explaining an arrival direction of sound outputted by the sound processing device according to the embodiment.

FIG. 6 is a flowchart of an operation performed by the sound processing device according to the embodiment.

FIG. 7 is a diagram for explaining an appropriate first angle according to a working example.

FIG. 8 is a diagram for explaining an appropriate first delay time according to the working example.

FIG. 9 is a diagram for explaining an appropriate first volume attenuation according to the working example.

FIG. 10 is a block diagram showing the functional configuration of a sound reproduction device according to a variation of the embodiment.

FIG. 11 is a block diagram showing a detailed functional configuration of a sound processing device according to the variation of the embodiment.

FIG. 12 is a diagram for explaining an arrival direction of sound outputted by the sound processing device according to the variation of the embodiment.

FIG. 13 is a flowchart of an operation performed by the sound processing device according to the variation of the embodiment.

### DESCRIPTION OF EMBODIMENT

### (Underlying Knowledge Forming Basis of the Present Disclosure)

There is known a technology relating to sound reproduction for causing a user to perceive a stereophonic sound in a virtual three-dimensional space (hereinafter also referred to as “three-dimensional sound field”) by controlling the position of a sound image, which is a user's sensory sound source object (see, for example, PTL 1). By localizing the sound image in a predetermined position in the virtual three-dimensional space, it is possible to cause the user to perceive the sound as if such sound was arriving from a direction parallel to the line that connects such predetermined position and the user (i.e., from a predetermined direction). To localize a sound image in the predetermined position in the virtual three-dimensional space as described above, for example, computation processing is required to generate, in the sound that has been picked up, interaural differences in sound arrival time, sound level (or sound pressure), etc. to enable the sound to be perceived as a stereophonic sound.

In recent years, online meeting systems have been actively used for communicating with a communication partner through bidirectional transmission and reception of video and sound, using a telecommunications line. In such online meeting systems, head-mounted sound reproduction devices such as headphones are widely used. In receiving sound with headphones, as represented by the case of such an online meeting system, for example, it is difficult to create and present sound in a three-dimensional sound field to cause the user to perceive such sound. It is known that, when the direction in which a display device showing a communication partner is present is set as the arrival direction of sound, the mere convolution of head-related transfer functions for causing the sound to be perceived as if the sound was arriving from such direction is not enough to provide a sufficient out-of-head feeling. Stated differently, since the sound image is localized inside of the user's head, the user has a sense of strangeness between the video showing the communication partner on the display device and the sound localized inside of the head. When continuing to listen to the sound with such sense of strangeness, the user can become fatigued more than necessary. The same problem can occur also in the case such as where the sound of contents utilizing VR, AR, or other three-dimensional video spaces is listened to, using sound reproduction devices such as headphones.

There is known a technology capable of creating and presenting sound in a three-dimensional sound field even with the use of headphones. Examples of such technology includes a method of simulating how reflected sounds are generated in a pseudo room to artificially generate and combine these reflected sounds and causing a user to listen to the resulting sound. With this, the sound that includes combined reflected sounds enables the user to perceive as if the original sound was arriving from a predetermined direction in the pseudo room. However, such method involves complicated computation to calculate the reflected sounds to be generated in the pseudo room and a large number of convolutions of head-related transfer functions to generate such reflected sounds. Since an enormous amount of computation is required for the processing of convoluting, to a target sound signal, head-related transfer functions for causing sound to be perceived as a reflected sound arriving from a certain direction, a large-scale computation device is required.

Meanwhile, it is also possible to create sound similar to a reflected sound by, for example, causing a time delay in a sound signal and performing filtering processing for volume attenuation. Such filtering processing, however, is not practical because of its poor capability of achieving the effects of creating and presenting sound in a three-dimensional sound field.

In view of the above, the present disclosure describes a sound processing device capable of achieving sufficient effects of creating and presenting sound in a three-dimensional sound field without the need for a large-scale computation device, by generating and combining on the order of one to several reflected sounds in causing the user to perceive sound, using a sound reproduction device such as headphones, as sound that arrives from a predetermined direction in a three-dimensional sound field.

More specifically, the sound processing device according to a first aspect of the present disclosure is a sound processing device that causes a user to perceive a reproduced sound as sound that arrives from a predetermined direction in a three-dimensional sound field. Such sound processing device includes: a first processing unit that generates a first output sound signal by convoluting, to sound information including the reproduced sound, a first head-related transfer function for localizing sound included in information as sound that arrives from the predetermined direction; a second processing unit that generates a second output sound signal by convoluting, to the sound information, a second head-related transfer function for localizing sound included in information as sound that arrives from a first direction and has a first delay time larger than 0 and a first volume attenuation larger than 0 with respect to the reproduced sound perceived by means of the first output sound signal, the first direction being a direction that forms a first angle larger than 0° and smaller than 360° with respect to the predetermined direction; and a combiner that combines the first output sound signal and the second output sound signal that are generated to output an output sound signal obtained by combining the first output sound signal and the second output sound signal.

In such sound processing device, the second output sound signal is localized as sound that arrives from the first direction and has the first delay time and the first volume attenuation. As such, the user perceives the sound as a reflected sound, which is the reproduced sound reflected at a pseudo reflection wall. For this reason, the reflected sound is perceived with the first delay time and the first volume attenuation, together with the reproduced sound, which is the direct sound. This enhances the out-of-head feeling at the position at which the sound image of the direct sound is localized. In particular, this processing simply requires at least the second output sound signal to be combined and outputted with the first output sound signal. Thus, the computation processing for generating the second output sound signal is simply required to be performed to achieve the effects of enhancing the out-of-head feeling of the direct sound. Consequently it is possible to cause the user to perceive a stereophonic sound in a more appropriate manner, while minimizing the computational cost required for the processing.

Also, for example, the sound processing device according to a second aspect of the present disclosure is the sound processing device according to the first aspect in which the output sound signal outputted is reproduced, using headphones or earphones placed on a head of the user.

With this, it is possible to cause the user to perceive a stereophonic sound in a more appropriate manner, using headphones or earphones placed on the head of the user.

Also, for example, the sound processing device according to a third aspect of the present disclosure is the sound processing device according to the first aspect or the second aspect in which the first angle is an angle within a range of angles greater than 90° and smaller than 270° with respect to the predetermined direction.

With this, when the predetermined direction from which the reproduced sound arrives overlaps the front direction of the user, the range of angles greater than 90° and smaller than 270° with respect to the predetermined direction is at the back side of the user. As such, the reflected sound arrives from the back side of the user, when the user is facing the direction of the reproduced sound. In localizing a reflected sound, it is effective to localize it at the back side of user 99 to make the presence of the reflected sound itself less perceivable. As such, with the foregoing configuration, it is possible to cause the user to perceive a stereophonic sound in a more appropriate manner.

Also, for example, the sound processing device according to a fourth aspect of the present disclosure is the sound processing device according to any one of the first aspect to the third aspect, further including a third processing unit that generates a third output sound signal by convoluting, to the sound information, a third head-related transfer function for localizing sound included in information as sound that arrives from a second direction and has a second delay time larger than 0 and a second volume attenuation larger than 0 with respect to the reproduced sound perceived by means of the first output sound signal, the second direction being a direction that forms a second angle larger than 0° and smaller than 360° with respect to the predetermined direction and different from the first angle. Here, the combiner outputs the output sound signal that is obtained by combining the first output sound signal, the second output sound signal, and the third output sound signal.

With this, the third output sound signal is further localized as sound that arrives from the second direction with the second delay time and the second volume attenuation. As such, the user perceives the sound as a reflected sound, which is the reproduced sound further reflected at a pseudo reflection wall. For this reason, the reflected sound is additionally perceived with the second delay time and the second volume attenuation, together with the reproduced sound, which is the direct sound, and the reflected sound of the second output sound signal. This further enhances the out-of-head feeling at the position at which the sound image of the direct sound is localized. As described above, by generating a small number of reflected sounds, which is two or more, to cause them to be perceived, it is possible to achieve significant effects of enhancing the out-of-head feeling at a relatively low computational cost. It is thus possible to cause the user to perceive a stereophonic sound in a more appropriate manner.

Also, for example, the sound processing device according to a fifth aspect of the present disclosure is the sound processing device according to the fourth aspect in which the second angle is an angle that is within a range of angles greater than 90° and smaller than 270° with respect to the predetermined direction and that satisfies that a difference angle obtained by subtracting the second angle from 360° does not agree with the first angle.

With this, when the predetermined direction from which the reproduced sound arrives overlaps the front direction of the user, the range of angles greater than 90° and smaller than 270° with respect to the predetermined direction is at the back side of the user. As such, the reflected sound arrives from the back side of the user, when the user is facing the direction of the reproduced sound. In localizing a reflected sound, it is effective to localize it at the back side of user 99 to make the presence of the reflected sound itself less perceivable. As such, with the foregoing configuration, it is possible to cause the user to perceive a stereophonic sound in a more appropriate manner.

Also, for example, the sound processing device according to a sixth aspect of the present disclosure is the sound processing device according to the fourth aspect or the fifth aspect in which the first delay time and the second delay time are mutually different delay times.

With this, it is possible to decrease the possibility that the reflected sound of the second output sound signal and the reflected sound of the third output sound signal are perceived as the same single reflected sound. It is thus possible to cause the user to perceive a stereophonic sound in a more appropriate manner by means of these two reflected sounds.

Also, for example, the sound processing device according to a seventh aspect of the present disclosure is the sound processing device according to any one of the fourth aspect to the sixth aspect in which the first volume attenuation and the second volume attenuation are mutually different volume attenuations.

With this, it is possible to decrease the possibility that the reflected sound of the second output sound signal and the reflected sound of the third output sound signal are perceived as the same single reflected sound. It is thus possible to cause the user to perceive a stereophonic sound in a more appropriate manner by means of these two reflected sounds.

Also, for example, the sound processing device according to an eighth aspect of the present disclosure is the sound processing device according to any one of the first aspect to the seventh aspect, further including: a dereverberation processing unit that performs, on sound included in information, dereverberation processing for decreasing a reverberation component included in the information. Here, the sound information is generated by performing the dereverberation processing on original sound information including the reverberation component, and includes, as the reproduced sound, sound that remains after decreasing the reverberation component from sound included in the original sound information.

With this, when the original sound information includes a reverberation component, it is possible to decrease such reverberation component to generate sound information. Then, the reproduced sound and the reflected sound are generated from the sound information, thereby causing the user to perceive a stereophonic sound in a more appropriate manner.

Also, for example, the sound processing device according to a ninth aspect of the present disclosure is the sound processing device according to any one of the first aspect to the eighth aspect, further including an obtainer that obtains a sensing result from a sensor that detects a movement of a head of the user. Here, the second processing unit convolutes, to the sound information, the second head-related transfer function in which an attenuation amount of the first volume attenuation is changed, based on the sensing result obtained.

With this, it is possible to change the attenuation amount of the second output sound signal, on the basis of the movement of the head of the user. When the direction from which the reflected sound arrives and the front direction of the user become closer as the result of the movement of the head of the user, for example, the user's attention can be drawn to the presence of the reflected sound itself, as a result of which the effects of enhancing the out-of-head feeling of the reproduced sound cannot be appropriately achieved. With this aspect, by increasing the attenuation amount (attenuating the volume) of the reflected sound in the above case, it is possible to reduce the possibility that the user′ attention is drawn to the reflected sound. It is thus possible to cause the user to perceive a stereophonic sound in a more appropriate manner.

Also, for example, the sound processing device according to a tenth aspect of the present disclosure is the sound processing device according to the ninth aspect, in which the first head-related transfer function is convoluted to localize sound included in information as sound that arrives from the predetermined direction and has a third volume attenuation larger than or equal to 0. The first processing unit convolutes, to the sound information, the first head-related transfer function in which an attenuation amount of the third volume attenuation is decreased, when the attenuation amount of the first volume attenuation in the second processing unit is increased, and convolutes, to the sound information, the first head-related transfer function in which the attenuation amount of the third volume attenuation is increased, when the attenuation amount of the first volume attenuation in the second processing unit is decreased.

With this, it is possible to change the attenuation amount of the reproduced sound in synchronization with the attenuation amount of the reflected sound. Moe specifically, when the attenuation amount of the reflected sound is increased (when the volume is attenuated), the attenuation amount of the reproduced sound is decreased (the volume is increased). Meanwhile, when the attenuation amount of the reflected sound is decreased (when the volume is increased), the attenuation amount of the reproduced sound is decreased (the volume is decreased). In this manner, it is possible to complement the volumes between the reproduced sound and the reflected sound to enable an overall volume in the three-dimensional sound field not to be extremely changed.

Also, for example, the sound processing device according to an eleventh aspect of the present disclosure is the sound processing device according to any one of the fifth aspect to the tenth aspect citing the fourth aspect, further including an obtainer that obtains a sensing result from a sensor that detects a movement of a head of the user. Here, the third processing unit convolutes, to the sound information, the third head-related transfer function in which an attenuation amount of the second volume attenuation is changed, based on the sensing result obtained.

With this, it is possible to change the attenuation amount of the third output sound signal, on the basis of the movement of the head of the user. When the direction from which the reflected sound arrives and the front direction of the user become closer as the result of the movement of the head of the user, for example, the user's attention can be drawn to the presence of the reflected sound itself, as a result of which the effects of enhancing the out-of-head feeling of the reproduced sound cannot be appropriately achieved. With this aspect, by increasing the attenuation amount (attenuating the volume) of the reflected sound in the above case, it is possible to reduce the possibility that the user′ attention is drawn to the reflected sound. It is thus possible to cause the user to perceive a stereophonic sound in a more appropriate manner.

Also, for example, the sound processing device according to a twelfth aspect of the present disclosure is the sound processing device according to any one of the first aspect to the eleventh aspect, in which at least one of the first angle, the first delay time, or the first volume attenuation is adjusted by the user.

With this, it is possible to adjust at least one of the first angle, the first delay time, or the first volume attenuation, in accordance with the user's own feeling.

Also, for example, the sound processing device according to a thirteenth aspect of the present disclosure is the sound processing device according to any one of the fifth aspect to the twelfth aspect citing the fourth aspect, in which at least one of the second angle, the second delay time, or the second volume attenuation is adjusted by the user.

With this, it is possible to adjust at least one of the second angle, the second delay time, or the second volume attenuation, in accordance with the user's own feeling.

Also, for example, the sound processing device according to a fourteenth aspect of the present disclosure is the sound processing device according to any one of the first aspect to the thirteenth aspect, in which the sound information is generated, based on original sound information that includes the reproduced sound and a reverberation component, and the first delay time is a delay time smaller than a delay time of the reverberation component with respect to the reproduced sound.

With this, the sound perceived by the user by means of the first output sound signal has a smaller delay time than that of the reverberation component that is generated in the sound pickup environment of the original sound information. As such, the sound that is perceived by means of the first output sound signal becomes less perceivable as noise such as reverberation. Stated differently, it is possible to cause the user to perceive, as the reflected sound, the sound that is perceived by means of the first output sound signal, in an appropriate manner.

Also, for example, the sound processing device according to a fifteenth aspect of the present disclosure is the sound processing device according to any one of the fifth aspect to the fourteenth aspect citing the fourth aspect, in which the sound information is generated, based on original sound information that includes the reproduced sound and a reverberation component, and the second delay time is a delay time smaller than a delay time of the reverberation component with respect to the reproduced sound.

With this, the sound perceived by the user by means of the second output sound signal has a smaller delay time than that of the reverberation component that is generated in the sound pickup environment of the original sound information. As such, the sound that is perceived by means of the first output sound signal becomes less perceivable as noise such as reverberation. Stated differently, it is possible to cause the user to perceive, as the reflected sound, the sound that is perceived by means of the first output sound signal, in an appropriate manner.

The sound processing method according to a sixteenth aspect of the present disclosure is a sound processing method of causing a user to perceive a reproduced sound as sound that arrives from a predetermined direction in a three-dimensional sound field. Such sound processing method includes: generating a first output sound signal by convoluting, to sound information including the reproduced sound, a first head-related transfer function for localizing sound included in information as sound that arrives from the predetermined direction; generating a second output sound signal by convoluting, to the sound information, a second head-related transfer function for localizing sound included in information as sound that arrives from a first direction and has a first delay time larger than 0 and a first volume attenuation larger than 0 with respect to the reproduced sound perceived by means of the first output sound signal, the first direction being a direction that forms a first angle larger than 0° and smaller than 360° with respect to the predetermined direction; and combining the first output sound signal and the second output sound signal that are generated to output an output sound signal obtained by combining the first output sound signal and the second output sound signal.

Such sound processing method is capable of achieving the same effects as those achieved by the foregoing sound processing device.

Also, the recoding medium according to a seventeenth aspect of the present disclosure is a non-transitory computer-readable recording medium having recorded thereon a program for causing a computer to execute the foregoing sound processing method.

Such recording medium is capable of achieving the same effects, using a computer, as those achieved by the foregoing sound processing device.

### Embodiment

### [Overview]

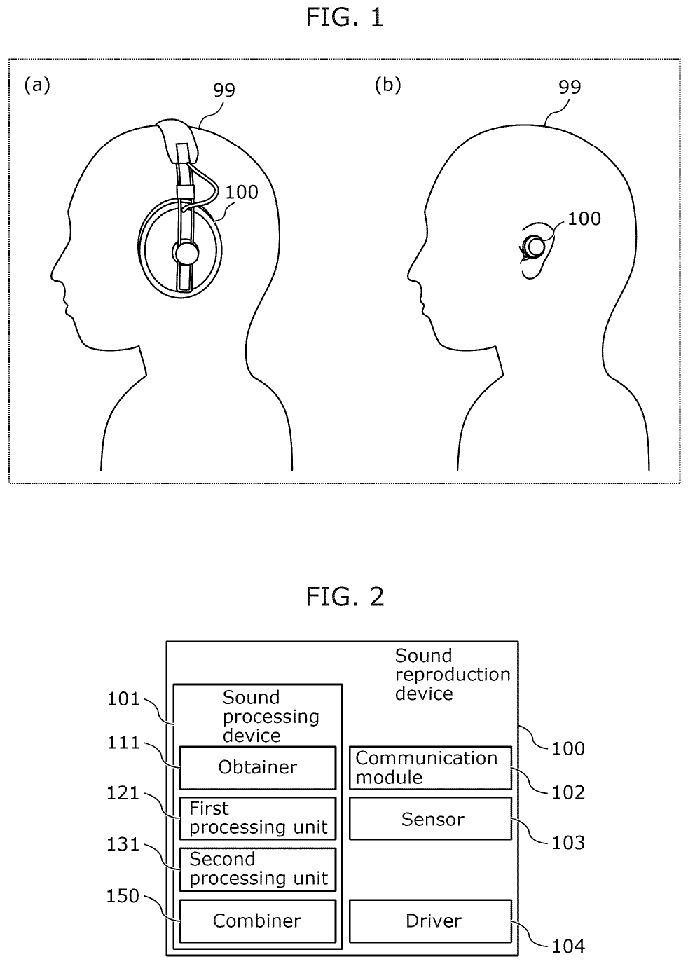

First, an overview of the sound reproduction device according to an embodiment will be described. FIG. 1 is a schematic diagram showing usage examples of the sound reproduction device according to the embodiment. In FIG. 1, (a) shows one of the two examples in which user 99 uses sound reproduction device 100 and (b) shows the other of the two examples in which user 99 uses another sound reproduction device 100.

As described above, sound reproduction device 100 shown in FIG. 1 is used together with a display device for image display and a device for stereoscopic video reproduction (both devices are not shown).

Sound reproduction device 100 is a sound presentation device that is placed on the head of user 99. As such, sound reproduction device 100 moves integrally with the head of user 99. Sound reproduction device 100 in the present embodiment may be, for example, an over-ear headphone device as shown in (a) in FIG. 1 or two earplug devices (in-ear headphone devices) that are individually worn in both ears of user 99 as shown in (b) in FIG. 1. These two devices communicate with each other to present the sound for the right ear and the sound for the left ear in synchronization with each other.

Note that the sound reproduction device of the present disclosure is not limited to a head-mounted sound reproduction device such as an over-ear headphone device and in-ear headphone devices. For example, the sound reproduction device of the present disclosure is also applicable to, for example, a sound reproduction device that is located in proximity of the ears of user 99, with a speaker not placed on user 99, such as a headrest speaker.

Sound reproduction device 100 causes the user to perceive as if the user was moving the head in the three-dimensional sound field, by changing sounds to be presented in accordance with the movement of the head of user 99. For this reason, as described above, sound reproduction device 100 moves the three-dimensional sound field in the opposite direction of the movement of the user, in response to the movement of user 99.

### [Configuration]

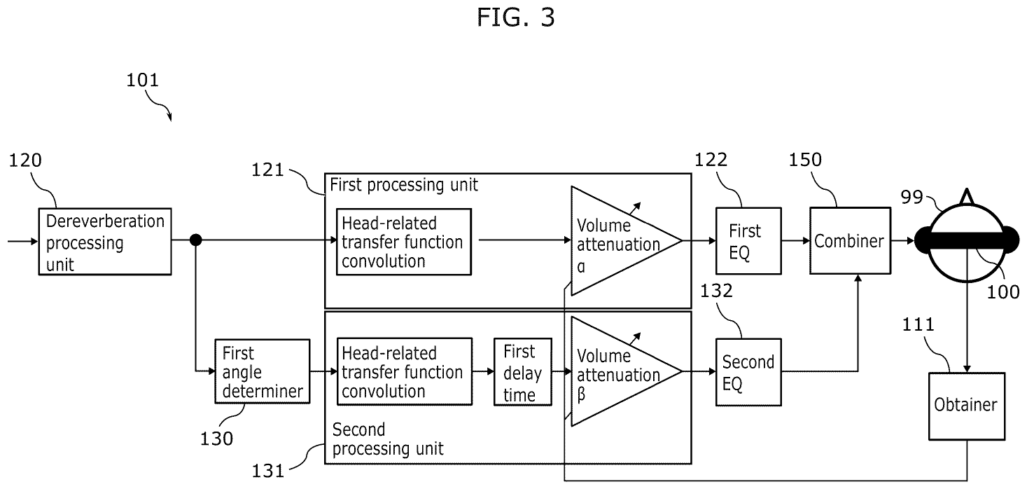

Next, with reference to FIG. 2 and FIG. 3, the configuration of sound reproduction device 100 according to the present embodiment will be described. FIG. 2 is a block diagram showing the functional configuration of the sound reproduction device according to the embodiment. FIG. 3 is a block diagram showing a more detailed functional configuration of the sound processing device according to the embodiment.

As shown in FIG. 2, sound reproduction device 100 according to the present embodiment includes sound processing device 101, communication module 102, sensor 103, and driver 104.

Sound processing device 101 is an arithmetic device for performing various signal processing in sound reproduction device 100. Sound processing device 101 includes, for example, a processor and a memory, where the processor executes a program stored in the memory, thereby achieving various functions.

Sound processing device 101 includes obtainer 111, first processing unit 121, second processing unit 131, and combiner 150. Obtainer 111 will be described later when communication module 102 is described, and combiner 150 will be described later when driver 104 is described.

First processing unit 121 generates an output sound signal of a reproduced sound. First processing unit 121 is a function unit that generates a first output sound signal by convoluting a first head-related transfer function for localizing sound included in information as sound that arrives from a predetermined direction. First processing unit 121 convolutes, to input sound information, a head-related transfer function for localizing sound in a predetermined direction, and outputs, via volume attenuation α (third volume attenuation), the first output sound signal that is an attenuated signal. These processes performed by first processing unit 121 are generally interpreted as first head-related transfer function convolution. The first output sound signal is inputted to first EQ 122 to be subjected to adjustment of low-frequency and high-frequency sounds, and then provided to combiner 150.

Second processing unit 131 generates an output sound signal of a first reflected sound. Second processing unit 131 is a function unit that generates a second output sound signal by convoluting a second head-related transfer function for localizing sound included in information as sound that arrives from a first direction forming a first angle larger than 0° and smaller than 360° with respect to the predetermined direction and that has a first delay time larger than 0 and a first volume attenuation larger than 0 with respect to the reproduced sound that is perceived by means of the first output sound signal. Second processing unit 131 convolutes, to the input sound information, a head-related transfer function for localizing sound in the first direction, and outputs, via volume attenuation β (first volume attenuation), the second output sound signal that is an attenuated signal. These processes performed by second processing unit 131 are generally interpreted as second head-related transfer function convolution. The second output sound signal is inputted to second EQ 132 to be subjected to adjustment of low-frequency and high-frequency sounds, and then provided to combiner 150. Note that before the sound information is inputted to second processing unit 131, first angle determiner 130 adds, to the sound information, information for designating a head-related transfer function to be convoluted later.

Communication module 102 is an interface device for receiving an input of sound information to sound reproduction device 100. Communication module 102 includes, for example, an antenna and a signal convertor to receive the sound information from an external device over wireless communication. More specifically, communication module 102 receives a wireless signal indicating the sound information that has been converted into a format for wireless communication, using the antenna, and re-converts the wireless signal into the sound information, using the signal converter. With this, sound reproduction device 100 obtains the sound information from the external device over wireless communication. Obtainer 111 obtains the sound information obtained by communication module 102. In this manner, the sound information is inputted to sound processing device 101. Note that communication between sound reproduction device 100 and the external device may be performed over wired communication.

Sound processing device 101 also includes dereverberation processing unit 120 shown in FIG. 3. When the original sound includes a reverberation component in generating and combing reflected sounds, that is, when a sound component is included that is inputted to a sound pickup device with delay due to reflection in the sound pickup environment, for example, the effects are reduced of enhancing the out-of-head feeling that are produced by combining the reflected sounds. For this reason, sound processing device 101 performs, on sound included in information, dereverberation processing of decreasing the reverberation component included in such information. By performing the dereverberation processing, it is possible to generate, from the original sound information including the reproduced sound to be reproduced and the reverberation component, sound information that includes, as the reproduced sound, the sound which remains after decreasing the reverberation component from the sound included in the original sound information, and inputs such generated sound information to first processing unit 121 and second processing unit 131. Dereverberation processing unit 120 may also be disposed at the previous stage of obtainer 111 or the subsequent stage of obtainer 111.

The sound information obtained by sound reproduction device 100 is encoded, for example, in a predetermined format such as MPEG-H 3D Audio (ISO/IEC 23008-3). For example, the encoded sound information includes information about the reproduced sound to be reproduced by sound reproduction device 100, and information relating to the localization position that is information for localizing the sound image of such sound in a predetermined position in the three-dimensional sound field (i.e., for causing the sound to be perceived as sound that arrives form the predetermined direction), that is, information relating to the predetermined direction. The sound information includes, for example, information relating to a plurality of sounds including a first reproduced sound and a second reproduced sound. Sound images to be generated when the respective sounds are reproduced are localized to cause the sounds to be perceived as sounds that arrive from different directions in the three-dimensional sound field.

Such stereophonic sound enhances a sense of realism of content that is viewed, for example, together with images that are viewed using a display device. Note that the sound information may include only the information about the reproduced sound. In this case, the information relating to the predetermined direction may be separately obtained. The sound information includes first sound information relating to the first reproduced sound and second sound information relating to the second reproduced sound as described above, but items of sound information that individually include these items of information may be separately obtained and simultaneously reproduced to localize the sound images at different positions in the three-dimensional sound field. As described above, the sound information to be inputted is not limited to having a specific form, and thus sound reproduction device 100 (especially sound processing device 101) is simply required to include obtainer 111 that corresponds to various forms of sound information.

Obtainer 111 in the present embodiment includes, for example, an encoded sound information input receiver, a decoding processing unit, and a sensing information input receiver.

The encoded sound information input receiver is a processing unit to which encoded sound information (stated differently, sound information that has been encoded) obtained by obtainer 111 is inputted. The encoded sound information input receiver outputs the input sound information to the decoding processing unit. The decoding processing unit is a processing unit that decodes the sound information (stated differently, performs decoding on the sound information) outputted from the encoded sound information input receiver, thereby generating information relating to a predetermined sound included in the sound information and the information relating to the predetermined direction in a format to be used in the subsequent processes. The sensing information input receiver is described below, together with the function of sensor 103.

Sensor 103 is a device for detecting the moving speed of the head of user 99. Sensor 103 is configured using a combination of various sensors used for movement detection, such as a gyroscope sensor and an acceleration sensor. In the present embodiment, sensor 103 is included inside of sound reproduction device 100, but may also be included, for example, inside of an external device such as a stereoscopic video reproduction device that operates in response to the movement of the head of user 99 as in the case of sound reproduction device 100. In this case, sensor 103 may not be included in sound reproduction device 100. Also, an external imaging device, for example, may be used as sensor 103 to capture images of the movement of the head of user 99 and detect the movement of the head of user 99 by processing such captured images.

Sensor 103 is integrally fixed to the housing of sound reproduction device 100, for example, to detect the speed of the movement of the housing. After placed on user 99, sound reproduction device 100 including such housing moves integrally with the head of user 99. Consequently, it is possible for sensor 103 to detect the moving speed of the head of user 99.

Sensor 103 may detect, as the amount of movement of the head of user 99, the amount of rotation about at least one of three axes of rotation that are orthogonal to each other in the three-dimensional space, or may detect the amount of displacement of at least one of these three axes serving as a displacement direction. Alternatively, sensor 103 may detect both the amount of rotation and the amount of displacement as the amount of movement of the head of user 99.

The sensing information input receiver of obtainer 111 obtains, from sensor 103, the moving speed of the head of user 99. More specifically, the sensing information input receiver obtains, as the moving speed, the amount of movement of the head of user 99 detected by sensor 103 per unit time. In this manner, the sensing information input receiver obtains, as the sensing result, at least one of the rotation speed or the displacement speed from sensor 103. The amount of movement of the head of user 99 obtained here is used to determine the coordinates and the orientation of user 99 in the three-dimensional sound field. Sound reproduction device 100 determines a relative position of the sound image, on the basis of the determined coordinates and orientation of user 99, and reproduces the sound.

Further, in the present embodiment, the sensing result obtained from sensor 103 by the sensing information input receiver of obtainer 111 is used to control the attenuation amounts of volume attenuation α and volume attenuation β. Stated differently, the attenuation amounts of volume attenuation α and volume attenuation β automatically change in accordance with the sensing result. This is because user 99 can have the feeling of strangeness when user 99 faces toward the direction of a reflected sound and such reflected sound is clearly sounding from such direction. For this reason, the volume of a reflected sound is controlled to cause a larger amount of volume to be attenuated as the front direction of user 99 becomes closer in the direction of the reflected sound, when user 99 rotates the head. At the same time, the volume of the reproduced sound is increased (the attenuation amount is decreased) so that an overall volume will not be changed. Stated differently, when the attenuation amount of volume attenuation β in second processing unit 131 is increased, first processing unit 121 decreases the attenuation amount of volume attenuation α, and when the attenuation amount of volume attenuation β in second processing unit 131 is decreased, first processing unit 121 increases the attenuation amount of volume attenuation α.

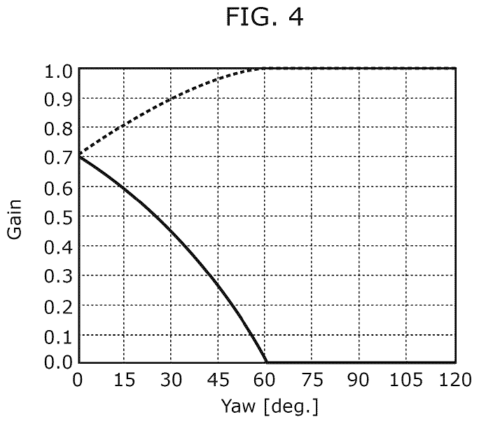

FIG. 4 is a diagram for explaining volume attenuation according to the embodiment. The diagram shows the attenuation amount of volume attenuation α (broken line) and the attenuation amount of volume attenuation β (solid line) relative to the rotation angle (yaw angle) when user 99 rotates the head about the axis that is parallel to the up-down direction of the head of user 99. Note that the first angle here is set at 120°. Here, the attenuation amount of volume attenuation α and the attenuation amount of volume attenuation β are calculated on the basis of Expression (1) shown below.

$$\begin{matrix}[ Math . 1 ] & \\ \sqrt{{α}^{2} + {β}^{2}} = 1 & ( 1 )\end{matrix}$$

Note that in the above expression, “a” indicates the attenuation amount (gain) of volume attenuation α and “B” indicates the attenuation amount (gain) of volume attenuation β. It is known from this example that no reflected sound is generated when user 99 rotates the head to an angle of 60° relative to the reflected sound that is set in the direction of 120° which is formed with respect to the predetermined direction, that is, half the angle of 120°. In this manner, sound processing device 101 changes the attenuation amounts of the reproduced sound and the reflected sound as appropriate so that the reflected sound itself will not be a cause of the feeling of strangeness. The relationship between volume attenuation α and volume attenuation β that have been described using the above Expression (1) is an example, and thus any relationship may be used so long as the attenuation amount of a reflected sound is more increased as user 99 rotates the head closer in the direction of the reflected sound. Also, the foregoing relationship may be established not only between volume attenuation α and volume attenuation, but also between volume attenuation α and volume attenuation γ for generating another reflected sound with volume attenuation γ (to be described in a variation).

Combiner 150 is a function unit that combines the generated output sound signals and outputs the resulting signal to driver 104. Combiner 150 outputs an output sound signal that is a combined signal obtained by adding the first output sound signal and the second output sound signal. Combiner 150 further generates a waveform signal by performing signal conversion on the basis of the output sound signal, such as signal conversion from digital to analog, causes driver 104 to generate sound waves on the basis of the waveform signal, and presents the sound to user 99. Driver 104 includes, for example, a diaphragm and a driving mechanism such as a magnet and a voice coil. Driver 104 causes the driving mechanism to operate in response to the waveform signal to cause the diaphragm to vibrate by the driving mechanism. In this manner, driver 104 causes sound waves to be generated by the vibration of the diaphragm that is responsive to the output sound signal. Such sound waves propagate through the air to reach the ears of user 99, and such user 99 perceives the sound.

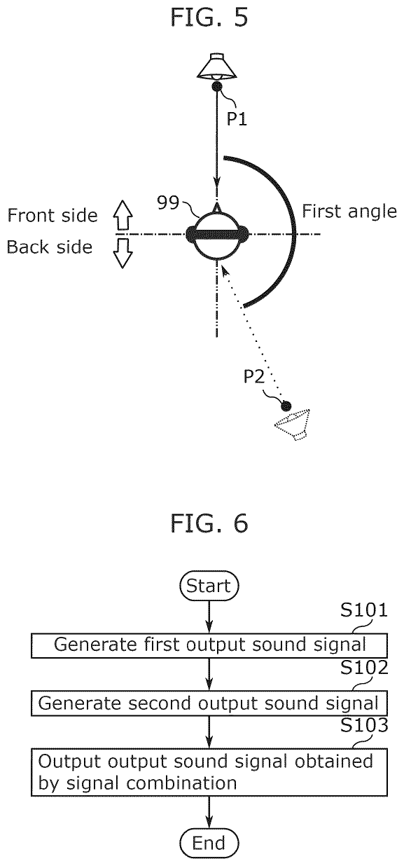

When the output sound signal outputted from combiner 150 in the above manner is reproduced by driver 104, a sound field as shown in FIG. 5 is formed. FIG. 5 is a diagram for explaining the arrival direction of the sound outputted by the sound processing device according to the embodiment. FIG. 5 shows a virtual three-dimensional sound field in a plan view from the direction that lines along the up-down direction of the head of user 99. FIG. 5 shows user 99 in a posture facing the front direction, which is the upper side of the paper surface. Such user 99 is in an upright posture that is vertical to the paper surface. The predetermined direction in which the reproduced sound is to be localized is set in the front direction of user 99. Note that position P1 at which the reproduced sound is localized is indicated with a black circle, and a virtual speaker is also illustrated.

As shown in the diagram, the first reflected sound is localized in the direction that forms at the first angle in the clockwise direction from the predetermined direction (position P2).

Also, the dash-dot line that extends in the left-right direction of user 99 in the diagram indicates a virtual boundary at which the head of user 99 is divided into front and back. Such boundary may be a surface that lies along the outer-ear canals of user 99, a surface that passes through the points at the backmost ends of the ear conchs of user 99, or a surface that simply passes through the barycenter of the head of user 99. It is known that easiness of sound perception differs between front and back of such boundary, that is, between front and back of user 99. In localizing a reflected sound, it is effective to localize it at the back side of user 99 to make the presence of the reflected sound itself less perceivable. For this reason, the first angle may be set within a range of angles larger than 90° and smaller 270° with respect to the predetermined direction.

Note that the first angle, the first delay time, and the first volume attenuation described above are numerical values that are preliminarily set by sound processing device 101 or numerical values that change in response to the sensing result of sensor 103. However, at least one of these may be configured to be adjustable, using a numerical value freely inputted by user 99. Stated differently, sound processing device 101 may receive an input from user 99 for adjusting at least one of the first angle, the first delay time, or the first volume attenuation.

### [Operation]

Next, with reference to FIG. 6, the operation performed by sound reproduction device 100 described above will be described. FIG. 6 is a flowchart of the operation performed by the sound processing device according to the embodiment. First, when the operation of sound reproduction device 100 is started, obtainer 111 obtains the original sound information via communication module 102. The original sound information includes a reverberation component in addition to the reproduced sound. As such, sound information is generated which includes the reproduced sound and from which the reverberation component has been decreased by dereverberation processing unit 120.

First processing unit 121 generates the first output sound signal by convoluting, to the sound information, the first head-related transfer function for localizing sound included in the information as sound that arrives from a predetermined direction (S101). Subsequently, second processing unit 131 generates the second output sound signal by convoluting, to the sound information, the second head-related transfer function for localizing sound included in the information as sound that arrives from the first direction and has the first delay time larger than 0 and the first volume attenuation larger than 0 with respect to the reproduced sound that is perceived by means of the first output sound signal (S102).

The order of executing step S101 and step S102 described above may be changed or these steps may be executed in parallel. Subsequently, combiner 150 combines the first output sound signal and the second output sound signal that are generated, and outputs the output sound signal obtained by combining these signals (step S103). Driver 104 reproduces the output sound signal outputted in this manner, thereby superimposing the reflected sound onto the reproduced sound to cause user 99 to perceive the resulting sound as a three-dimensional sound. In particular, since only one reflected sound is generated, it is possible to cause user 99 to perceive an effective stereophonic sound without the need for, for example, a large-scale arithmetic device.

### Working Example

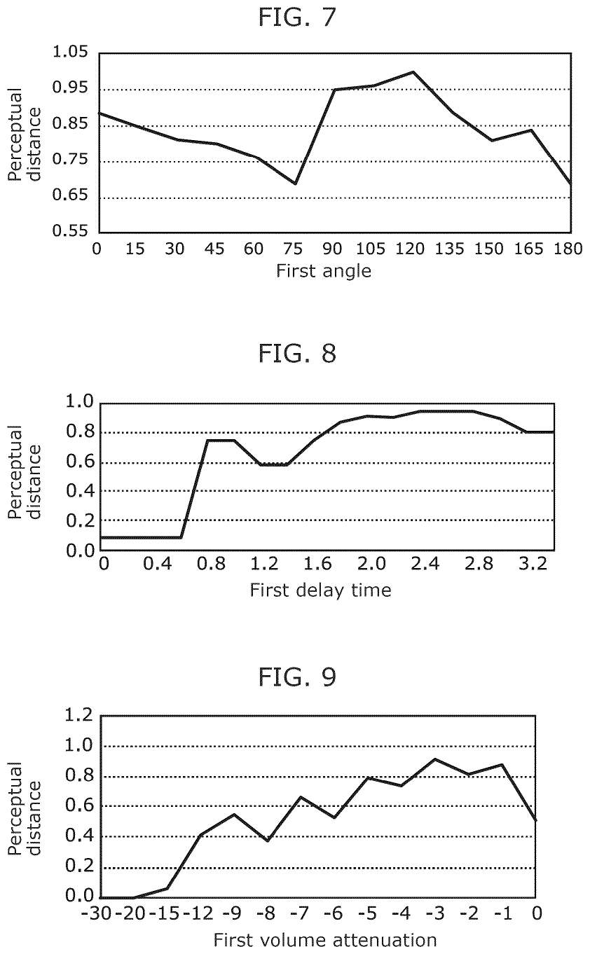

FIG. 7 is a diagram for explaining an appropriate first angle according to a working example. FIG. 8 is a diagram for explaining an appropriate first delay time according to the working example. FIG. 9 is a diagram for explaining an appropriate first volume attenuation according to the working example.

FIG. 7 shows distances to the position of a sound image perceived by a test subject (perceptual distances), when the first angle is changed from 0° to 180°, that is, how distant in the predetermined direction the sound was perceivable. It can be said that the larger a perceptual distance, the stronger the out-of-head feeling and more effectively a three-dimensional sound is perceived. Note that the conditions set here are: the amount of the first volume attenuation is-3 dB and the first delay time is 2.2 ms. As shown in FIG. 7, a strong out-of-head feeling is achieved when the first direction is set in the direction of 105° or 120°.

FIG. 8 shows perceptual distances perceived by a test subject when the first delay time is changed from 0 ms to 3.4 ms. Note that the conditions set here are: the amount of the first volume attenuation is −3 dB and the first angle is 105°. As shown in FIG. 8, a strong out-of-head feeling is achieved when the first delay time is set from 2.4 ms to 2.8 ms, and a sufficient out-of-head feeling is achieved when the first delay time is set from 1.8 ms to 3.0 ms. However, since an increase in delay time leads to the degradation in sound quality, it is appropriate to set the first delay time at a relatively short time. In view of this, the first delay time may be set from 1.8 ms to 2.4 ms, such as 2.2 ms.

FIG. 9 shows perceptual distances perceived by a test subject when the attenuation amount of the first volume attenuation is changed from −30 dB to 0 dB. Note that the conditions set here are: the first delay time is 2.2 ms and the first angle is 105°. As shown in FIG. 9, a strong out-of-head feeling is achieved by setting the attenuation amount of the first volume attenuation between −5 dB and −3 dB. No improvement is observed in the out-of-head feeling when the attenuation amount of −3 dB or greater is set. Note that a reflected sound of a large volume can be a cause of the degradation in sound quality, and thus it can be thought that the attenuation amount is preferably as small as possible.

### [Variation]

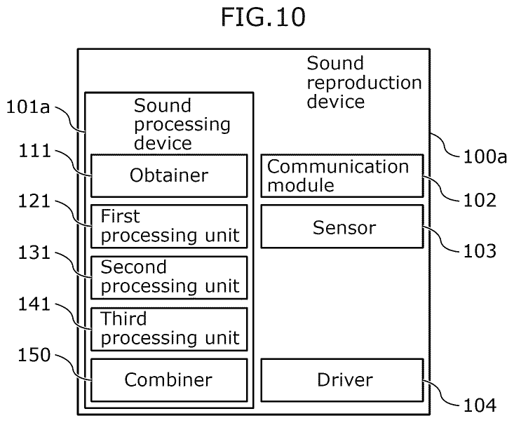

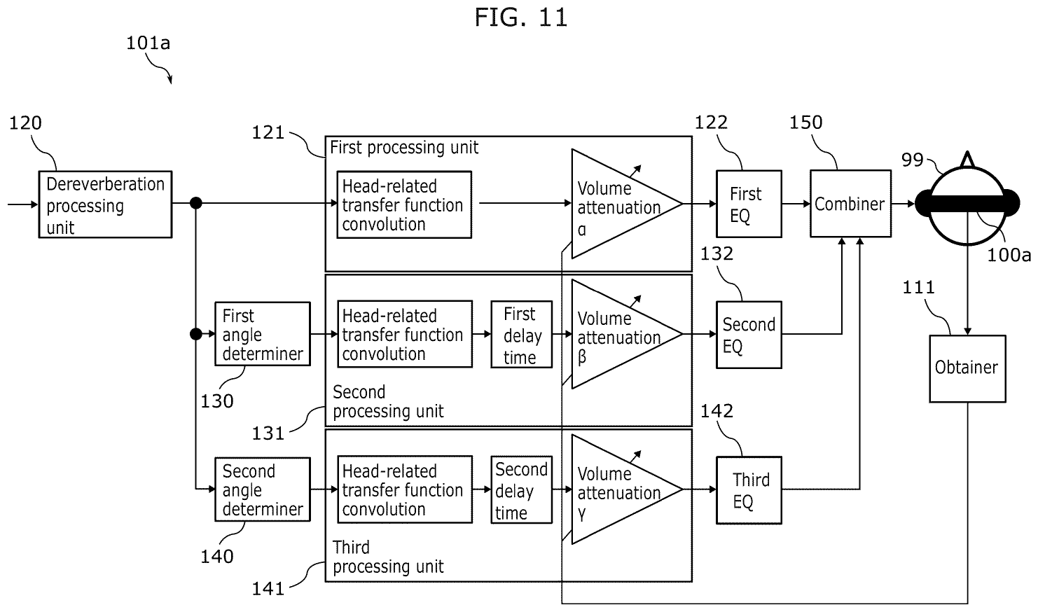

Next, a sound processing device according to a variation of the foregoing embodiment will be described. In the following description of the variation, the descriptions of substantially the same elements as those in the foregoing embodiment are omitted and thus the descriptions given above are referred to. FIG. 10 is a block diagram showing the functional configuration of the sound reproduction device according to the variation of the embodiment. FIG. 11 is a block diagram showing a detailed functional configuration of the sound processing device according to the variation of the embodiment. As shown in FIG. 10 and FIG. 11, sound reproduction device 100a according to the variation includes sound processing device 101a. The configuration of sound processing device 101a is different from that of sound processing device 101 according to the foregoing embodiment in that sound processing device 101a includes third processing unit 141.

Third processing unit 141 generates an output sound signal of a second reflected sound. Third processing unit 141 is a function unit that generates a third output sound signal by convoluting a third head-related transfer function for localizing sound included in information as sound that arrives from a second direction forming a second angle different from the first angle and larger than 0° and smaller than 360° with respect to the predetermined direction and that has a second delay time different from the first delay time and larger than 0 and a second volume attenuation different from the first volume attenuation and larger than 0 with respect to the reproduced sound that is perceived by means of the first output sound signal. Third processing unit 141 convolutes, to the input sound information, a head-related transfer function for localizing sound in the second direction, and outputs, via volume attenuation γ (second volume attenuation), the third output sound signal that is an attenuated signal. These processes performed by third processing unit 141 are generally interpreted as third head-related transfer function convolution. The third output sound signal is inputted to third EQ 142 to be subjected to adjustment of low-frequency and high-frequency sounds, and then provided to combiner 150. Note that before the sound information is inputted to third processing unit 141, second angle determiner 140 adds, to the sound information, information for designating a head-related transfer function to be convoluted later.

Combiner 150 is a function unit that combines the generated output sound signals and outputs the resulting signal to driver 104. Combiner 150 outputs an output sound signal that is a combined signal obtained by adding the first output sound signal, the second output sound signal, and the third output sound signal. Stated differently, in sound processing device 101a, second processing unit 131 and third processing unit 141 generate reflected sound signals that are different from each other, and combiner 150 superimposes these two signals onto the reproduced sound. When two reflected sounds are generated and superimposed onto the reproduced sound as in the present variation, it is possible to further enhance the effects of creating and presenting the sound in a three-dimensional sound field, depending on conditions.

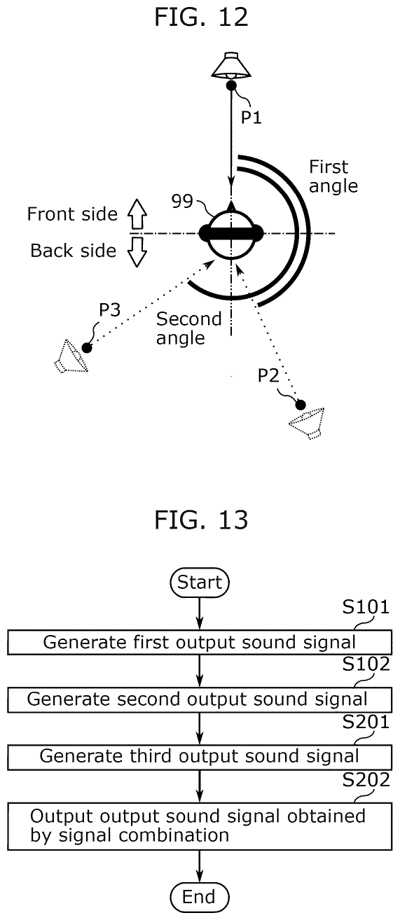

When the output sound signal outputted from combiner 150 in the above manner is reproduced by driver 104, a sound field as shown in FIG. 12 is formed. FIG. 12 is a diagram for explaining the arrival direction of the sound outputted by the sound processing device according to the embodiment. FIG. 12 shows a virtual three-dimensional sound field in a plan view from the same eye point as that of FIG. 5.

As shown in the diagram, the first reflected sound is localized in the direction that forms the first angle in the clockwise direction from the predetermined direction (position P2). Also, the second reflected sound is localized in the direction that forms the second angle in the clockwise direction from the predetermined direction (position P3). As shown in the diagram, the first angle and the second angle do not agree with each other, and are not in the directions that are symmetric with respect to the dash-dot-dot line that is parallel to the back of the front side of user 99 (parallel also to the predetermined direction). If the first direction and the second direction were symmetric, the two reflected sounds could be superimposed upon each other to be localized as a single reflected sound at the back of user 99, depending on conditions. For this reason, the second angle is an angle that satisfies that the difference angle obtained by subtracting the second angle from 360° does not agree with the first angle.

As also shown in the diagram, the first angle and the second angle are localized at the back side of user 99 with respect to the virtual boundary that divides the head of user 99 into front and back. As such, both the first angle and the second angle are set within a range of angles greater than 90° and smaller than 270° with respect to the predetermined direction.

Note that, as with the first angle, the first delay time, and the first volume attenuation, the second angle, the second delay time, and the second volume attenuation described above are also numerical values that are preliminarily set by sound processing device 101a, or numerical values that change in response to the sensing result of sensor 103. However, at least one of these may be configured to be adjustable, using a numerical value freely inputted by user 99. Stated differently, sound processing device 101a may receive an input from user 99 for adjusting at least one of the second angle, the second delay time, or the second volume attenuation.

### [Operation]

Next, with reference to FIG. 13, the operation performed by sound reproduction device 100a described above will be described. FIG. 13 is a flowchart of the operation performed by the sound processing device according to the embodiment. First, step S101 and step S102 are performed, as with the operation of sound processing device 101 that has been described with reference to FIG. 6. Subsequently, third processing unit 141 generates the third output sound signal by convoluting, to the sound information, the third head-related transfer function for localizing sound included in the information as sound that arrives from the second direction and has the second delay time larger than 0 and the second volume attenuation larger than 0 with respect to the reproduced sound that is perceived by means of the first output sound signal (S201).

The order of executing step S101, step S102, and S201 described above may be changed or these steps may be executed in parallel. Subsequently, combiner 150 combines the first output sound signal, the second output sound signal, and the third output sound signal that are generated, and outputs the output sound signal obtained by combining these signals (step S202). Driver 104 reproduces the output sound signal outputted in this manner, thereby superimposing the reflected sounds onto the reproduced sound to cause user 99 to perceive the resulting sound as a three-dimensional sound. In particular, since only two reflected sounds are generated, it is possible, also in this case, to cause user 99 to perceive an effective stereophonic sound without the need for, for example, a large-scale arithmetic device.

Note that the number of processing units may be further increased to superimpose three or more reflected sounds onto the reproduced sound.

### OTHER EMBODIMENTS

The embodiment has been described above, but the present disclosure is not limited to the foregoing embodiment.

For example, the foregoing embodiment describes an example in which the sound does not follow the movement of the head of the user, but the descriptions of the present disclosure are effective also in the case where the sound follows the movement of the head of the user. Stated differently, in the operation of causing the user to perceive a predetermined sound as sound that arrives from the first position which moves relative to the movement of the head of the user, a stereophonic sound filter may be selected to enhance variations, when such variations in the arrival direction of the predetermined sound are smaller than a threshold.

Also, for example, the sound reproduction device described in the foregoing embodiment may be realized by means of a single device that includes all of the elements or by means of a plurality of devices to which the functions are allocated and which operate in conjunction with each other. In the latter case, an information processing device such as a smartphone, a tablet terminal, and a PC may be used as a device that corresponds to a processing module.

In another example configuration different from the configuration described in the foregoing embodiment, it is also possible for the decoding processing unit to correct the original sound information, thereby selecting a changed stereophonic sound filter. More specifically, the decoding processing unit in the present example is a processing unit that generates information about a predetermined direction included in sound information and corrects the original sound information. Such decoding processing unit calculates an angular amount of variations in the predetermined direction on the time axis. When the calculated angular amount of variations in the predetermined direction is smaller than a threshold, the decoding processing unit corrects the information about the predetermined direction so that the user can perceive a predetermined sound which is more enhanced than in the case where the angular amount of variations in the predetermined direction is greater than or equal to the threshold. With this, by simply selecting a stereophonic sound filter that specifies the arrival direction from which the predetermined sound arrives on the basis of the corrected information about the predetermined direction outputted from the decoding processing unit, it is possible to apply the changed stereophonic sound filter in the foregoing embodiment.

As described above, the information processing method and so forth in the disclosure of the present application may be realized by correcting the information about the predetermined direction included in the original sound information. The decoding processing unit as described above realizes, for example, a sound reproduction device capable of achieving the same effects as those achieved by the disclosure of the present application, simply by replacing such decoding processing unit with a processing unit that performs decoding processing in a conventional stereophonic sound reproduction device.

Also, the sound reproduction device in the present disclosure can also be realized by means of a sound processing device that is connected to a reproduction device including only a driver, and that only outputs, to such reproduction device, an output sound signal, using a stereophonic sound filter that is selected on the basis of the obtained sound information. In this case, the sound processing device may be configured in the form of hardware that includes an exclusive circuit or as software that causes a general-purpose processor to execute specific processing.

Also, in the foregoing embodiment, processing executed by a specific processing unit may be executed by another processing unit. Also, the processing order of a plurality of processes may also be changed, and a plurality of processes may be executed in parallel.

Also, the elements in the foregoing embodiment may be realized by executing a software program suitable for the element. Each of the elements may be realized by means of a program executing unit, such as a CPU and a processor, reading and executing the software program recorded on a recording medium such as an HDD or a semiconductor memory.

Also, each of the elements may be configured in the form of an exclusive hardware product. Also, for example, the elements may be configured in the form of circuits (or integrated circuit). These circuits may form a single circuit as a whole or may be individual circuits. Each of these circuits may be a general-purpose circuit or an exclusive circuit.

Also, general or specific aspects of the present disclosure may be implemented in the form of a system, a device, a method, an integrated circuit, a computer program, or a computer-readable recording medium such as a CD-ROM. These general and specific aspects may also be implemented using any combination of systems, devices, methods, integrated circuits, computer programs, or recording media.

For example, the present disclosure may be configured in the form of a sound signal reproduction method executed by a computer, or a program for causing a computer to execute the sound signal reproduction method. The present disclosure may also be configured in the form of a non-transitory, computer-readable recording medium having recorded thereon such program.

In addition to the above, the present disclosure also includes an embodiment achieved by making various modifications to each embodiment that can be conceived by those skilled in the art, and an embodiment achieved by freely combining some of the elements and functions of each embodiment without departing from the essence of the present disclosure.

### INDUSTRIAL APPLICABILITY

The present disclosure is useful in reproducing sound, such as in causing a user to perceive a stereophonic sound.

1. A sound processing device that causes a user to perceive a reproduced sound as sound that arrives from a predetermined direction in a three-dimensional sound field, the sound processing device comprising:
a first processing unit that generates a first output sound signal by convoluting, to sound information including the reproduced sound, a first head-related transfer function for localizing sound included in information as sound that arrives from the predetermined direction;
a second processing unit that generates a second output sound signal by convoluting, to the sound information, a second head-related transfer function for localizing sound included in information as sound that arrives from a first direction and has a first delay time larger than 0 and a first volume attenuation larger than 0 with respect to the reproduced sound perceived by means of the first output sound signal, the first direction being a direction that forms a first angle larger than 0° and smaller than 360° with respect to the predetermined direction; and
a combiner that combines the first output sound signal and the second output sound signal that are generated to output an output sound signal obtained by combining the first output sound signal and the second output sound signal.

2. The sound processing device according to claim 1,
wherein the output sound signal outputted is reproduced, using headphones or earphones placed on a head of the user.

3. The sound processing device according to claim 1,
wherein the first angle is an angle within a range of angles greater than 90° and smaller than 270° with respect to the predetermined direction.

4. The sound processing device according to claim 1, further comprising:
a third processing unit that generates a third output sound signal by convoluting, to the sound information, a third head-related transfer function for localizing sound included in information as sound that arrives from a second direction and has a second delay time larger than 0 and a second volume attenuation larger than 0 with respect to the reproduced sound perceived by means of the first output sound signal, the second direction being a direction that forms a second angle larger than 0° and smaller than 360° with respect to the predetermined direction and different from the first angle,
wherein the combiner outputs the output sound signal that is obtained by combining the first output sound signal, the second output sound signal, and the third output sound signal.

5. The sound processing device according to claim 4,
wherein the second angle is an angle that is within a range of angles greater than 90° and smaller than 270° with respect to the predetermined direction and that satisfies that a difference angle obtained by subtracting the second angle from 360° does not agree with the first angle.

6. The sound processing device according to claim 4,
wherein the first delay time and the second delay time are mutually different delay times.

7. The sound processing device according to claim 4,
wherein the first volume attenuation and the second volume attenuation are mutually different volume attenuations.

8. The sound processing device according to claim 1, further comprising:
a dereverberation processing unit that performs, on sound included in information, dereverberation processing for decreasing a reverberation component included in the information,
wherein the sound information:
is generated by performing the dereverberation processing on original sound information including the reverberation component; and
includes, as the reproduced sound, sound that remains after decreasing the reverberation component from sound included in the original sound information.

9. The sound processing device according to claim 1, further comprising:
an obtainer that obtains a sensing result from a sensor that detects a movement of a head of the user,
wherein the second processing unit convolutes, to the sound information, the second head-related transfer function in which an attenuation amount of the first volume attenuation is changed, based on the sensing result obtained.

10. The sound processing device according to claim 9,
wherein the first head-related transfer function is convoluted to localize sound included in information as sound that arrives from the predetermined direction and has a third volume attenuation larger than or equal to 0,
the first processing unit:
convolutes, to the sound information, the first head-related transfer function in which an attenuation amount of the third volume attenuation is decreased, when the attenuation amount of the first volume attenuation in the second processing unit is increased; and
convolutes, to the sound information, the first head-related transfer function in which the attenuation amount of the third volume attenuation is increased, when the attenuation amount of the first volume attenuation in the second processing unit is decreased.

11. The sound processing device according to claim 5, further comprising:
an obtainer that obtains a sensing result from a sensor that detects a movement of a head of the user,
wherein the third processing unit convolutes, to the sound information, the third head-related transfer function in which an attenuation amount of the second volume attenuation is changed, based on the sensing result obtained.

12. The sound processing device according to claim 1,
wherein at least one of the first angle, the first delay time, or the first volume attenuation is adjusted by the user.

13. The sound processing device according to claim 5,
wherein at least one of the second angle, the second delay time, or the second volume attenuation is adjusted by the user.

14. The sound processing device according to claim 1,
wherein the sound information is generated, based on original sound information that includes the reproduced sound and a reverberation component, and
the first delay time is a delay time smaller than a delay time of the reverberation component with respect to the reproduced sound.

15. The sound processing device according to claim 5,
wherein the sound information is generated, based on original sound information that includes the reproduced sound and a reverberation component, and
the second delay time is a delay time smaller than a delay time of the reverberation component with respect to the reproduced sound.

16. A sound processing method of causing a user to perceive a reproduced sound as sound that arrives from a predetermined direction in a three-dimensional sound field, the sound processing method comprising:
generating a first output sound signal by convoluting, to sound information including the reproduced sound, a first head-related transfer function for localizing sound included in information as sound that arrives from the predetermined direction;
generating a second output sound signal by convoluting, to the sound information, a second head-related transfer function for localizing sound included in information as sound that arrives from a first direction and has a first delay time larger than 0 and a first volume attenuation larger than 0 with respect to the reproduced sound perceived by means of the first output sound signal, the first direction being a direction that forms a first angle larger than 0° and smaller than 360° with respect to the predetermined direction; and
combining the first output sound signal and the second output sound signal that are generated to output an output sound signal obtained by combining the first output sound signal and the second output sound signal.

17. A non-transitory computer-readable recording medium having recorded thereon a program for causing a computer to execute the sound processing method according to claim 16.
